(19) United States
(12) Patent Application Publication
(10) Pub. No.: US 2006/0258803 A1
(43) Pub. Date: Nov. 16, 2006

(54) Method for the production of powder-type ethylene vinyl alcohol mixed polymers

(76) Inventor: Kurt Stark, Weilersbach (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/556,000

(22) PCT Filed: Apr. 29, 2004
(86) PCT No.: PCT/EP04/04564

§ 371 Date: Nov. 8, 2005

(30) Foreign Application Priority Data
May 15, 2003 (DE) 103219420

(51) Int. Cl. C08F 16/06

(52) U.S. Cl. 525/56

(57) ABSTRACT

Pulverulent ethylene-vinyl alcohol copolymers may be produced in highly pure form, in particular containing no surfactant residues, by hydrolyzing an ethylene-vinylester copolymer in alcoholic solution and precipitating the copolymer in particulate form employing a cooling temperature gradient, optionally with addition of water.

The invention relates to a process for preparing pulverulent ethylene-vinyl alcohol copolymers (EVOH) by free-radical polymerization of ethylene and one or more vinyl esters, and optionally further monomers copolymerizable therewith, subsequent hydrolysis of the thus obtained ethylene-vinyl ester copolymers to give ethylene-vinyl alcohol copolymers and precipitation of the hydrolysis product.

Owing to their advantageous property profile, ethylene-vinyl alcohol copolymers find use in many kinds of applications. Ethylene-vinyl alcohol copolymers are notable for chemical resistance, good adhesion to various substrates, transparency, antistatic properties, oxygen-impermeable films, good thermo-plastic processibility, for example by means of extrusion. Owing to these advantageous properties, ethylene-vinyl alcohol copolymers are used as foils and films in food packaging, for the production of chemical-resistant bottles and tanks, and for the protection of pipes and pipelines.

The prior art discloses a series of processes for preparing ethylene-vinyl alcohol copolymers, for example in JP-A 60-199004, JP-A 11-80263, EP-A 997250 and EP-A 1085028. In these processes, ethylene and vinyl acetate are polymerized free-radically in alcoholic solution. Subsequently, the vinyl acetate units are hydrolyzed with an alcoholic solution of bases, for example methanolic NaOH, to give vinyl alcohol. The ethylene-vinyl alcohol copolymers are isolated by means of extrusion of the copolymers into a coagulation bath, typically water or a water/methanol mixture. The thus obtained extrudates are finally cut into pellets. After the pellets have been dried, they can then be processed by means of extrusion to give the desired moldings.

These processes generally afford very high molecular weight ethylene-vinyl alcohol copolymers which have correspondingly high melt viscosity but can, though, be processed without any problem by means of extrusion. However, a disadvantage is that only poor yields are achieved in the hydrolysis, and the pellets have a high solvent content which has to be removed in the course of drying. In order to obtain pulverulent products, the pellets would have to be ground in an additional, costly and inconvenient step.

U.S. Pat. No. 4,100,335, U.S. Pat. No. 4,104,453 and U.S. Pat. No. 4,820,803 disclose that ethylene-vinyl acetate copolymers are dispersed in water in the presence of emulsifiers or salts in the molten state, subsequently hydrolyzed, then cooled below the softening temperature of the hydrolysis product and can be isolated as a powder by means of filtration. A disadvantage is the introduction of assistants which greatly contaminate the pulverulent end product. U.S. Pat. No. 4,719,259 describes a process in which the ethylene-vinyl alcohol copolymer is precipitated with water in the form of a paste.

It is an object of the invention to provide a process by which ethylene-vinyl alcohol copolymers are obtainable in powder form in a simple manner and with high purity.

The invention provides a process for preparing pulverulent ethylene-vinyl alcohol copolymers by free-radical polymerization of ethylene and one or more vinyl esters, and optionally further monomers copolymerizable therewith, subsequent hydrolysis of the thus obtained ethylene-vinyl ester copolymers to give ethylene-vinyl alcohol copolymers, characterized in that the ethylene-vinyl alcohol copolymer, after the hydrolysis, is precipitated from alcoholic solution by means of cooling with a temperature gradient, and optional addition of water, the temperature gradient in the case of ethylene-vinyl alcohol copolymers which derive from low molecular weight ethylene-vinyl ester copolymers having a weight-average molecular weight Mw of from 2000 to 100 000 g/mol being from −0.1° C./min to −10° C./min, and the temperature gradient in the case of ethylene-vinyl alcohol copolymers which derive from high molecular weight ethylene-vinyl ester copolymers having a weight-average molecular weight Mw of >100 000 g/mol being from −0.1° C./min to −1° C./min.

The ethylene-vinyl ester polymers can be prepared in a known manner by means of free-radical polymerization; preferably by bulk polymerization, emulsion polymerization, suspension polymerization or by polymerization in organic solvents, more preferably in alcoholic solution with monohydric aliphatic alcohols having from 1 to 4 carbon atoms or mixtures thereof as a solvent. Suitable solvents are, for example, methanol, ethanol, propanol, isopropanol and an ethanol-isopropanol mixture. The polymerization is carried out under reflux at a temperature of from 35° C. to 100° C. Ethylene is injected at a pressure of from 10 to 90 bar abs. The free-radical initiation is effected by means of addition of common initiators. Examples of common initiators are percarbonates such as cyclohexyl peroxydicarbonate, peresters such as t-butyl perneodecanoate or t-butyl perpivalate, peroxide initiators such as tert-butyl hydroperoxide, diacyl peroxides such as dilauroyl peroxide, and azoinitiators such as azobisisobutyronitrile (AIBN), 2,2′-azobis(4-methoxy-2,4-dimethylvaleronitrile).

To obtain relatively low molecular weight products, i.e. having a weight-average molecular weight Mw of from 2000 to 100 000 g/mol, preferably from 5000 to 60 000 g/mol, preference is given to using relatively high amounts of initiator, of preferably from 0.2 to 1.0% by weight, more preferably from 0.4 to 0.8% by weight, based in each case on the total weight of the comonomers without the ethylene fraction. In order to obtain relatively high molecular weight products, i.e. products having a weight-average molecular weight Mw>100 000 g/mol, preference is given to polymerizing with an amount of initiator of from 0.01 to 0.1% by weight, based on the total weight of the comonomers without the ethylene fraction.

The monomers may be initially charged in their entirety, metered in in their entirety or initially charged in fractions, and the remainder metered in after the initiation of the polymerization. In a preferred embodiment, in particular for the formation of low molecular weight copolymers, the vinyl ester fraction is initially charged to an extent of from 5 to 50% by weight, more preferably from 15 to 30% by weight, and the remaining fraction is metered in in each case. The initiator is initially charged preferably to an extent of from 5 to 50% by weight, more preferably from 15 to 30% by weight, and the remaining fraction is metered in in each case.

The molecular weight can also be adjusted in the manner known to those skilled in the art by polymerization in the presence of molecular weight regulators. Suitable regulators are, for example, alcohols such as ethanol or isopropanol, aldehydes such as acetaldehyde or propionaldehyde, mercaptans such as mercaptopropionic acid and dodecyl mercaptan, silane-containing regulators such as mercaptosilanes, for example 3-mercaptopropyltrimethoxysilane. Preference is given to polymerizing in methanol or in solvents having high transfer rate such as ethanol or isopropanol or mixtures thereof. The molecular weight can also be adjusted via the temperature, the initiator type and concentration, and via the solvent content.

Suitable vinyl esters are vinyl esters of unbranched or branched carboxylic acids having from 1 to 18 carbon atoms. Preferred vinyl esters are vinyl acetate, 1-methylvinyl acetate, vinyl propionate, vinyl butyrate, vinyl 2-ethylhexanoate, vinyl laurate, vinyl pivalate, and vinyl esters of α-branched monocarboxylic acids having from 5 to 13 carbon atoms, for example VeoVa9^{R} or VeoVa10^{R} (trade names of Shell). Particular preference is given to vinyl acetate.

The ethylene fraction in the copolymer is generally from 5 to 75 mol %, preferably from 20 to 60 mol %, more preferably from 25 to 50 mol %. Greatest preference is given to ethylene-vinyl acetate copolymers having the ethylene fractions specified.

In addition to vinyl esters, one or more monomers from the group comprising methacrylic esters and acrylic esters of alcohols having from 1 to 15 carbon atoms, alpha-olefins having from 3 to 12 carbon atoms, dienes, vinylaromatics and vinyl halides may optionally also be copolymerized. Suitable monomers from the group of the esters of acrylic acid or methacrylic acid are esters of unbranched or branched alcohols having from 1 to 15 carbon atoms. Preferred methacrylic esters or acrylic esters are methyl acrylate, methyl methacrylate, ethyl acrylate, ethyl methacrylate, propyl acrylate, propyl methacrylate, n-, iso- and t-butyl acrylate, n-, iso- and t-butyl methacrylate, 2-ethylhexyl acrylate, norbornyl acrylate. Suitable alpha-olefins are, for example, propene, isobutylene, 1-butene, 1-hexene, 1-octene, 1-dodecene. Suitable dienes are 1,3-butadiene and isoprene. The vinylaromatics copolymerized may be styrene and vinyltoluene. From the group of the vinyl halides, preference is given to vinyl chloride and vinylidene chloride. The fraction of these comonomers is such that the sum of the ethylene and vinyl ester fractions is >50 mol % in the ethylene-vinyl ester polymer.

Optionally, functional comonomers may also be present in a fraction of preferably from 0.1 to 25 mol %. Examples thereof are ethylenically unsaturated mono- and dicarboxylic acids, preferably acrylic acid, methacrylic acid, fumaric acid, crotonic acid, itaconic acid and maleic acid; ethylenically unsaturated carboxamides and carbonitriles, preferably N-vinylformamide, acrylamide and acrylonitrile; mono- and diesters of fumaric acid and maleic acid such as the diethyl and diisopropyl esters, and also maleic anhydride, ethylenically unsaturated sulfonic acids or salts thereof, preferably vinylsulfonic acid, 2-acrylamido-2-methylpropanesulfonic acid; alkyl vinyl ethers, vinyl ketones, N-vinylpyrrolidone; vinyl- and methacryloylsilanes such as vinyltrimethoxysilane and methacryloyloxypropyltrimethoxysilane; mercaptosilane. Further examples are precrosslinked comonomers such as ethylenically polyunsaturated comonomers, for example divinyl adipate, diallyl maleate, allyl methacrylate, butanediol diacrylate or triallyl cyanurate, or post-crosslinked comonomers, for example acrylamidoglycolic acid (AGA), methyl methacryloylamidoglycolate (MAGME), N-methylolacrylamide (NMA), N-methylolmethacrylamide, N-methylolallylcarbamate, alkyl ethers such as the isobutoxy ether or esters of N-methylolacrylamide, of N-methylolmethacrylamide and of N-methylolallyl carbamate.

The hydrolysis (transesterification) of the ethylene-vinyl ester copolymer is effected in a manner known per se, for example by the kneader process or in a stirred tank, under alkaline or acidic conditions, with addition of acid or base. The ethylene-vinyl ester copolymer is preferably present in alcoholic solution with monohydric aliphatic alcohols having 1 to 4 carbon atoms or mixtures thereof as a solvent. Particular preference is given to methanol and an ethanol/isopropanol mixture. The content of ethylene-vinyl ester copolymer in the solution is from 20 to 85% by weight, preferably from 30 to 80% by weight.

To initiate the hydrolysis, the customary acidic or alkaline catalysts are used. Acid catalysts are, for example, strong mineral acids such as hydrochloric acid or sulfuric acid, or strong organic acids such as aliphatic or aromatic sulphonic acids. Preference is given to using alkaline catalysts. These are, for example, the hydroxides, alkoxides and carbonates of alkali metals or alkaline earth metals. Preference is given to the hydroxides of lithium, sodium and potassium; particular preference is given to sodium hydroxide. The alkaline catalysts are used either in solid form (100%) or in the form of their aqueous or alcoholic solutions, preferably in alcoholic solution, and more preferably dissolved in the same alcohol which is used to dissolve the ethylene-vinyl ester copolymer. Most preferred is a methanolic solution of NaOH. The amounts of alkaline catalyst used are generally from 0.2 to 20.0% by weight based on the ethylene-vinyl ester copolymer.

The hydrolysis is carried out generally at temperatures of from 40° C. to 90° C., preferably from 50° C. to 85° C. In the batchwise mode, the alcoholic polyvinyl ester solution is fed to a reaction vessel, generally a stirred tank or a kneader. Addition of the catalyst solution initiates the hydrolysis. When the desired degree of hydrolysis is attained, generally at a degree of hydrolysis of the vinyl ester fraction of from 85 to 100 mol %, preferably from 95 to 100 mol %, the hydrolysis is terminated. Preference is given to distilling off the ester formed in the transesterification during the hydrolysis reaction.

In the case of acid-catalyzed hydrolysis, the termination is effected by addition of alkaline reagents. These are, for example, the hydroxides, alkoxides and carbonates of alkali metals or alkaline earth metals. Preference is given to the hydroxides of lithium, sodium and potassium; particular preference is given to sodium hydroxide. In the case of the preferred alkali-catalyzed hydrolysis, the termination is effected by addition of acid reagents such as carboxylic acids or mineral acids; or of neutral reagents such as carboxylic esters. Preference is given to carboxylic esters such as methyl acetate or ethyl acetate, and also to relatively strong carboxylic acids and mineral acids, preferably having a pKa value of less than 4.5, more preferably having a pKa value of less than 2.5. Suitable mineral acids are, for example, hydrochloric acid, sulfuric acid and nitric acid; suitable carboxylic acids are, for example, acetic acid, oxalic acid, formic acid, aliphatic and aromatic sulfonic acids, and halocarboxylic acids such as mono-, di- or trichloroacetic acid.

After the hydrolysis reaction has ended, the ethylene-vinyl alcohol copolymer formed is removed from the liquid phase by precipitation.

In the case of ethylene-vinyl alcohol copolymers which derive from low molecular weight ethylene-vinyl ester copolymers having a weight-average molecular weight Mw of from 2000 to 100 000 g/mol, preferably from 5000 to 60 000 g/mol, the temperature gradient is from −0.1° C./min to −10° C./min, preferably from −1° C./min to −10° C./min.

In the case of ethylene-vinyl alcohol copolymers which derive from high molecular weight ethylene-vinyl ester copolymers having a weight-average molecular weight Mw of >100 000 g/mol, the temperature gradient is from −0.1° C./min to −1° C./min, preferably from −0.1° C./min to −0.5° C./min.

In general, cooling is effected to a temperature which is above the Tg of the solvent-containing ethylene-vinyl alcohol copolymer but below the melting point of the ethylene-vinyl alcohol copolymer. Preference is given to cooling to a temperature of from 10° C. to 35° C.

In a preferred embodiment, in the case of the high molecular weight ethylene-vinyl alcohol copolymers, cooling is effected initially with relatively high cooling power, i.e. a temperature gradient of from −1° C./min to −10° C./min, to a temperature of preferably from 40° C. to 70° C., and the cooling is subsequently continued with a lower temperature gradient of from −0.1° C./min to −1° C./min, down to a temperature of from 10° C. to 35°.

The precipitation of the ethylene-vinyl alcohol copolymer is preferably promoted by addition of water. To this end, water is added during, preferably after, the cooling to the desired end temperature. The amount of water is generally from 0.3 times to 5.0 times, preferably from 0.8 times to 2.5 times, the total amount of the ethylene-vinyl ester copolymer used. The temperature of the water corresponds generally to room temperature or to the temperature of the cooled hydrolysis mixture. The procedure may also be to distill off the alcohol fraction after the precipitation and to replace it gradually with the corresponding amount of water.

The precipitated ethylene-vinyl alcohol copolymer can be removed by means of filtration and is generally present with a residual moisture content of ≦50%. The product is typically dried, for example with hot air, and is present in powder form after the drying. The particle size, determined as the mean volume diameter Dv, is from 20 to 2000 μm, preferably from 100 to 1000 μm. The desired particle size can be controlled by the process, i.e. via the temperature gradient in the cooling and precipitation, via the addition of water and its amount, and via the stirrer speed in the crystallization. The complex melt viscosity of the products is preferably from 0.5 to 100 000 Pas, in particular from 1 to 1000 Pas (at 180° C.; oscillating measurement at 1 Hz with plate/plate test system, instrument: Bohlin CVO 120 HR).

In a preferred embodiment, the resulting powder is resuspended in water, optionally freed of solvent residues by distillation or stripping, and the pulverulent product is isolated by filtration. To remove alkali metal salts and to establish the desired ash content, the powder can optionally also be washed with water.

To prevent discoloration in the melt, i.e. to increase the thermal stability, to prevent gel bodies or fish eyes in the melt, and to improve adhesion, the powder may optionally also be doped. Suitable dopants are known to those skilled in the art, for example carboxylic acids such as acetic acid, lactic acid, ascorbic acid, citric acid, hydroxy lactones; salts such as alkali metal, alkaline earth metal salts, and salts of the elements of the 3rd main group with inorganic or organic anions, such as sodium acetate, potassium acetate, calcium acetate and magnesium acetate; boron compounds such as boric acid, boric esters (borates) and borate salts; further phosphorus-containing compounds such as salts of phosphoric acid (mono- to trivalent) or of phosphonic acid (mono- to bivalent) such as NaH₂PO₄, Na₂HPO₄. The doping is effected preferably in the course of resuspension, by addition of an aqueous solution of the substances mentioned. The amounts added depend upon the desired property profile.

The ethylene-vinyl alcohol copolymers may optionally also be admixed with additives, for example fillers, UV absorbers, plasticizers, antioxidants, flame retardants, extenders, thermal stabilizers, thermoplastics, adhesion promoters.

The ethylene-vinyl alcohol copolymers may be used to produce foils, films and laminates, and to produce moldings. Further fields of use are those as a coating, as an additive for powder coating materials, as an adhesive and as a binder in building materials.

The advantages of this process can be summarized as follows:

It is possible to obtain low molecular weight products for which the range of the molecular weight can be very large. The low molecular weight ethylene-vinyl ester copolymers (Mw≦100 000 g/mol), particularly the very low molecular weight ethylene-vinyl ester copolymers having Mw≦50 000 g/mol, can be converted by the process to readily processible, pulverulent ethylene-vinyl alcohol copolymers. The resulting products have a homogeneous structure. The low solution viscosity leads to advantages in the polymerization: it is still possible to stir solutions having a solids content of up to 95%.

No Tromsdorff effect occurs. Accordingly, the conversion of vinyl acetate can be conducted to virtually 100%, i.e. very high yields, since vinyl acetate is polymerized almost completely. This results in very simple demonomerization: vinyl acetate which is in any case already very efficiently polymerized and therefore only present in a small amount can be removed very readily owing to the low solution viscosity. The content of vinyl acetate residual monomer can be adjusted to values of 20 ppm and lower. In the hydrolysis, this leads to no alkali being consumed by impurities and in particular to no acetaldehyde being formed from vinyl acetate (in an alkaline medium, acetaldehyde leads by aldol condensation to yellow discoloration of the EVOH end product).

Depending on the molecular weight, the solution of the low molecular weight resin is still pumpable with a very high solids content of from approx. 70 to 80% and can be fed to the hydrolysis at a very high percentage content. Overall, this saves a very large amount of solvent. Ethylene-vinyl ester copolymers having low molecular weights afford ethylene-vinyl alcohol copolymers having very good and advantageous melt flow.

### EXAMPLES

Preparation of the Ethylene-Vinyl Acetate Solid Resins:

### Example A

### High Molecular Weight Solid Resin

A 19-liter pressure autoclave was initially charged with 789.45 g of methanol, 9.52 kg of vinyl acetate, 1.88 g of PPV (tert-butyl perpivalate, 75% by weight in aliphatics, 0.0148% by weight based on VAc). The vessel was heated to 70° C. and 60 bar of ethylene were injected, and the ethylene pressure was retained up to the end of the reaction. Subsequently, the reaction ran at 70° C. for 7 h up to a solids content of 59.8%. At this solids content, the mixture coagulated, i.e. mixing and thus removal of the heat of reaction were no longer possible. At this point, the polymerization was, however, already complete, since the initiator had been consumed. The decompression vessel was then initially charged with 4 kg of methanol, and 4 kg of methanol were metered in at the same time that the mixture was decompressed. After the decompression, the vessel was heated for distillation, and fresh methanol which corresponded to the amount distilled off was introduced into the vessel every 30 min (demonomerization).

Analyses:

Solids content SC: 30.55% (in methanol);

Viscosity (Höppler—10% in ethyl acetate): 14.34 mPas;

Acid number AN (methanol): 5.61 mg KOH/g;

Residual vinyl acetate: 55 ppm; hydrolysis number: 519.05 mg KOH/g;

Ethylene content from ¹H NMR: 20.69% by weight (44.54 mol %);

SEC M_{w}=114632, Mₙ=35223, polydispersity=3.52 (NB: eluent is always THF; the data are relative based on polystyrene standards);

Tg of the dried resin: 0.9° C. N.B.: the Tg of ethylene-containing solid resins can be estimated very simply by the following formula (Fox equation): 1/Tg=% by wt. (Et)/180K+% by wt. (VAc)/316K. A theoretical value of 0.13° C. is calculated here.

### Example B

### Low Molecular Weight Solid Resin

A 19-liter pressure autoclave was initially charged with 2250 g of ethanol, 411.29 g of isopropanol, 2.38 kg of vinyl acetate and 14.3 g of PPV (tert-butyl perpivalate, 75% by weight in aliphatics). The vessel was heated to 70° C. and 60 bar of ethylene were injected, and the ethylene pressure was retained until the monomer metering had ended. Once 70° C. had been attained, the initiator metering started, which consisted of 417.22 g of ethanol and 55.63 g of PPV (tert-butyl perpivalate, 75% by weight in aliphatics). This metering ran over 430 min with a metering rate of 66 g/h.

10 min after the start of the initiator metering, the monomer metering started, which consisted of 7.15 kg of vinyl acetate. This metering ran over 360 min.

After the initiator metering had ended, the temperature of 70° C. was retained for another 90 min. Subsequently, the mixture was decompressed. After the decompression, the vessel was heated for distillation, and fresh methanol which corresponded to the amount distilled off was introduced into the vessel every 30 min (demonomerization and solvent exchange).

Analyses:

SC: 45.55% (in methanol); viscosity (Höppler—10% in ethyl acetate): 2.23 mPas; AN (methanol): 5.05 mg KOH/g;

Residual vinyl acetate: 16 ppm; hydrolysis number: 425.37 mg KOH/g;

Ethylene content from ¹H NMR: 30.48% by weight (57.44 mol %);

SEC M_{w}=23666, Mₙ=8900, polydispersity=2.66;

Tg of the dried resin: −17.0° C.

N.B.: a theoretical value of −16.3° C. is calculated here.

Preparation of the Ethylene-Vinyl Alcohol Powder:

### Example 1

### High Molecular Weight EVOH, Two Temperature Gradients

In a 3-liter jacketed, heatable glass reaction vessel (with distillation head with condenser, and dropping funnel), 838 g of a 35.8% by weight methanolic solution of an ethylene-vinyl acetate copolymer which has been obtained analogously to example A, contains 36.25 mol % of ethylene and 63.75 mol % of vinyl acetate and has a weight-average molecular weight Mw of 175581 g/mol were weighed in. This solution was diluted by addition of 162 g of methanol so as to give a 30% by weight solution. Subsequently, the solution was heated with stirring (200 rpm, blade stirrer) to a jacket temperature of 80° C. Once the temperature had been attained, the hydrolysis process was started by adding dropwise 333 g of a 9% by weight methanolic sodium hydroxide solution, corresponding to 30 g of solid NaOH=10% by weight of the amount of solid resin. The metering was effected by twice adding alkali for 15 minutes each time at an interval of 30 minutes. During the metered addition and for 1 h 40 min thereafter, a total of 800 ml of methyl acetate/methanol solvent mixture were distilled off under reduced pressure and replaced by methanol. Subsequently, the hydrolyzed solution was cooled first to 60° C. at full cooling power (−2° C./min). From then on, the mixture was cooled slowly to 30° C. using a temperature ramp of −0.17° C./min, so that the ethylene-vinyl alcohol copolymer was able to crystallize.

After the cooling, 500 g of distilled water were added and stirred in briefly. This resulted in the ethylene-containing polyvinyl alcohol precipitating out as a powder. A solid-liquid separation was then undertaken through a suction filter. The precipitated pulverulent solid was very efficiently separable from the suspension. The filtercake was placed back into the reaction vessel and resuspended with 1 1 of dist. water. Distillation at a jacket temperature of 50° C. under reduced pressure then removed the remaining solvent (stripping). Subsequently, the mixture was cooled back to room temperature, the solid again removed from the suspension through a suction filter and the filtercake washed with 2 1 of dist. water.

A fine pulverulent EVOH having a hydrolysis number of 0.78 mg KOH/g was obtained.

Analyses:

Composition from ¹H NMR: 26.56% by weight (36.25 mol %) of ethylene; 0.12% by weight of VAc; 73.32% by weight of VOH;

DSC analysis: Tg: 56.92° C.; peak temperature Tm (peak) of the melting point: 179.35° C.; melt enthalpy Hm: 86.45 J/g

Particle size of the product (Coulter analysis): surface area 774.2 cm²/g; mean volume diameter Dv 821.3 μm; number-average particle size Dn (mean) 0.0891 μm.

### Example 2

### High Molecular Weight EVOH, One-Stage Cooling with Low Temperature Gradient

A 120-liter jacketed, heatable reaction vessel (with distillation head with condenser, and metering pump) was charged with 34.6 kg of a 49.9% by weight solid resin solution of an ethylene-vinyl acetate copolymer which has been obtained analogously to example A, contains 44.0 mol % of ethylene and 56.0 mol % of vinyl acetate, and has an average molecular weight Mw of 111794 g/mol, and this solution was diluted to a solids content of 31% by addition of 20.95 kg of methanol. Subsequently, the solution was heated with stirring (95 rpm, anchor stirrer) to a jacket temperature of 70° C. Once the temperature had been attained, the hydrolysis process was started by metering in 20.31 kg of an 8.5% by weight methanolic sodium hydroxide solution, corresponding to 1.73 kg of solid NaOH=10% by weight of the amount of solid resin. The metered addition was effected within 1 h 20 min. During the metered addition and for another 2 h 15 min thereafter, a total of 31.5 kg of methyl acetate/methanol solvent mixture was distilled off under reduced pressure and replaced by 10 kg of methanol, i.e. the solution was slightly concentrated. Subsequently, the hydrolyzed solution was cooled to 23° C. using a temperature ramp of −0.5° C./min. During the cooling, at 60° C., the solution was adjusted using 300 ml of 100% acetic acid from pH 9.4 to pH 7.3. The cooled solution was then stirred at 23° C. and a stirrer speed of 45 rpm for 18 h 20 min. After this “crystallization time”, 40 kg of distilled water were added and stirred in. To remove the solvent, the suspension was then heated to a jacket temperature of 50° C., and distilled (stripped) under reduced pressure. In total, 38 kg of solvent mixture were distilled off in this way, in the course of which dist. water was added gradually in portions of 10 kg (a total of 60 kg).

After cooling to room temperature, the solid-liquid separation was then undertaken by means of a suction filter with inlaid linen cloth. The pulverulent solid could be separated very efficiently from the suspension (very good through-flow), so that the filtercake could be washed without problems with 20 kg of distilled water.

A fine pulverulent EVOH having a hydrolysis number of 28.7 mg KOH/g was obtained.

Analyses:

Composition from ¹H NMR: 32.61% by weight (44.00 mol %) of ethylene; 4.41% by weight of VAc; 62.98% by weight of VOH;

DSC analysis: Tg: 51.2° C.; peak temperature Tm (peak) of the melting point: 164.3° C.; melt enthalpy Hm: 91.3 J/g

Particle size of the product (Coulter analysis): surface area 223.7 cm²/g; mean volume diameter Dv 588.5 μm; number-average particle size Dn (mean) 1.55 μm.

### Example 3

### Low Molecular Weight EVOH

In a 3-liter jacketed, heatable glass reaction vessel (with distillation head and condenser, and dropping funnel), 1084 g of a 73.8% methanolic solid resin solution of the ethylene-vinyl acetate copolymer which was obtained in example B, contains 57.44 mol % of ethylene and 42.56 mol % of vinyl acetate, and has an average molecular weight Mw of 23666 g/mol were weighed in. Subsequently, the solution was heated with stirring (200 rpm, blade stirrer) to a jacket temperature of 80° C. Once the temperature had been attained, the hydrolysis process was started by dropwise addition of 800 g of a 10% by weight methanolic sodium hydroxide solution, corresponding to 80 g of solid NaOH=10% of the amount of solid resin. The metered addition was effected within 1 hour. During the metered addition and for 1 h 15 min thereafter, a total of 763 g of methyl acetate/methanol solvent mixture was distilled off under reduced pressure and replaced by 343 g of methanol.

Subsequently, the hydrolyzed solution was cooled to 23° C. using a temperature ramp of −1° C./min. This (partly) crystallized the EVOH. During the cooling, at 60° C., the solution was adjusted using 20 ml of 100% acetic acid from pH 10.5 to pH 7.5. After the cooling, 800 g of dist. water were added and stirred in briefly, which precipitated the (partly) crystalline EVOH in the form of a powder. The solid-liquid separation was then undertaken by means of a suction filter. The pulverulent solid could be separated very efficiently from the suspension. The filtercake was reinserted into the reaction vessel and resuspended with 1 1 of dist. water. The residual solvent was then removed by distillation at a jacket temperature of 45° C. and reduced pressure (stripping). Subsequently, the mixture was cooled back to room temperature, the solid was again removed from the suspension by means of a suction filter, and the filtercake was washed with 2 1 of dist. water (very good flow-through).

A white, finely pulverulent EVOH having a hydrolysis number of 12.6 mg KOH/g was obtained.

Analyses:

Composition from ¹H NMR: 45.77% by weight (57.44 mol %) of ethylene; 1.94% by weight of VAc; 52.29% by weight of VOH.

DSC analysis: Tg: 17.3° C.; peak temperature Tm (peak) of the melting point: 125.5° C.; melt enthalpy Hm: 64.0 J/g

Particle size of the pulverulent product (Coulter analysis): surface area 2316 cm²/g; mean volume diameter Dv 217.6 μm; number-average particle size Dn (mean) 1.90 μm.

### Comparative example 4

### High Molecular Weight EVOH

In a 3-liter jacketed, heatable glass reaction vessel (with distillation head and condenser, and dropping funnel), 838 g of a 35.8% solid resin solution of an ethylene-vinyl acetate copolymer which has been obtained analogously to example A, contains 36.25 mol % of ethylene and 63.75 mol % of vinyl acetate, and has a weight-average molecular weight Mw of 175581 g/mol were weighed in. This solution was diluted by addition of 162 g of methanol, so as to result in a 30% solution. Subsequently, the solution was heated with stirring (200 rpm, blade stirrer) to a jacket temperature of 80° C. Once the temperature had been attained, the hydrolysis process was started by a dropwise addition of 333 g of a 9% methanolic sodium hydroxide solution, corresponding to 30 g of solid NaOH=10% of the amount of solid resin. The metered addition was effected by twice adding alkali for 15 minutes each at an interval of 30 minutes. During the metered addition and for 1 h 10 min thereafter, a total of 600 ml of methyl acetate/methanol solvent mixture were replaced by methanol. Subsequently, the hydrolyzed solution was cooled to 30° C. at full cooling output of the temperature control unit (−2° C./min) within 25 min. From a jacket temperature of approx. 38° C., the product plasticized in the solution to give rubber-like particles which, viewed overall, resembled a moss-like structure.

Thereafter, 500 g of dist. water were added and stirred in briefly, and then the solid-liquid separation was undertaken by means of a suction filter. Owing to the low flow-through, the separation was very laborious.

A plasticized EVOH having a hydrolysis number of 1.7 mg KOH/g was obtained. The very coarse particles had a reticulated structure and, viewed overall, resembled a moss structure.

Analyses:

Composition from ¹H NMR: 26.54% by weight (36.25 mol %) of ethylene; 0.26% by weight of VAc; 73.20% by weight of VOH.

DSC analysis: Tg: 54.55° C.; peak temperature Tm (peak) of the melting point: 175.73° C.; melt enthalpy Hm: 68.29 J/g

Particle size of the product (Coulter analysis): not done since a pulverulent product was not obtained.

### Example 5

### Low Molecular Weight EVOH Having a High Degree of Purity

In a 3-liter jacketed, heatable glass reaction vessel (with distillation head and condenser, and dropping funnel), 724.6 g of a 69.0% methanolic solid resin solution of an ethylene-vinyl acetate copolymer which has been obtained analogously to example B, contains 56.5 mol % of ethylene and 43.5 mol % of vinyl acetate, and has an average molecular weight Mw of 53463 g/mol were weighed in. Subsequently, the solution was heated with stirring (200 rpm, blade stirrer) to a jacket temperature of 60° C. Once the temperature had been attained, the hydrolysis process was started by adding dropwise 403 g of a 6.2% by weight methanolic sodium hydroxide solution, corresponding to 25 g of solid NaOH=5.0% of the amount of solid resin. The metered addition was effected by twice adding alkali for 15 minutes each at an interval of 30 minutes.

After a hydrolysis time of 5 hours, the mixture was cooled from 60° C. to 40° C. with a ramp of −3° C./min. This (partly) crystallized the ethylene-vinyl alcohol copolymer. With the stirrer stopped, 250 g of ethyl acetate were subsequently added for neutralization and stirred in briefly at 50 rpm. After an action time of the ethyl acetate of 10 min (without stirring), the precipitation of the crystalline ethylene-vinyl alcohol copolymer was completed by addition of 500 g of water (at a temperature of 23° C.). A suspension of finely divided powder was obtained.

Afterward, the suspension was reheated to 60° C., stirred at 100 rpm and distilled under reduced pressure. This removed 550 ml of solvent, and 950 ml of water were added in the course of the distillation. The suspension was then cooled to 23° C. at a ramp of −3° C./min. The solid-liquid separation was then undertaken by means of a suction filter.

The residue on the suction filter was introduced into a linen bag and washed under flowing water for 1 hour. The washed ethylene-vinyl alcohol copolymer in the linen bag was introduced back into the reaction vessel and resuspended with 1 1 of dist. water. At a jacket temperature of 60° C. and a stirrer speed of 100 rpm, residual solvent was removed under reduced pressure (stripping). Subsequently, the mixture was cooled again to room temperature (23° C.), the solid was again removed from the suspension by means of a suction filter, and the filtercake was washed with 2 1 of dist. water (very good flow-through). Finally, the product was dried in a vacuum drying cabinet.

A highly pure, finely pulverulent, white EVOH having a hydrolysis number of 22.1 mg KOH/g was obtained.

Analyses:

Composition from ¹H NMR: 44.5% by weight (56.5 mol %) of ethylene; 3.4% by weight of vinyl acetate; 52.1% by weight of vinyl alcohol.

DSC analysis: Tg: 31.1° C., Tm (peak) 118.6° C., melt enthalpy Hm=59.7 J/g;

Particle size of the pulverulent product (Coulter analysis): surface area 1775 cm²/g; mean volume diameter Dv 405 μm; number-average particle size Dn (mean) 0.103 μm.

### Comparative Example 6

### Low Molecular Weight EVOH, No Cooling with Temperature Gradient

As example 5, except with the difference that, directly after the hydrolysis at a jacket temperature of 60° C., neutralization was effected with 250 g of ethyl acetate, and 500 g of water were subsequently added. Since the ethylene-vinyl acetate copolymer had not yet crystallized at this time and was still in the plastic state at this time, the addition of water led to immediate coagulation, so that a “paste” was obtained. It was thus impossible to obtain a pulverulent product, since a controlled cooling rate over a certain temperature ramp would first have been required for this purpose.

### Example 7

### Low Molecular Weight EVOH

In a 3-liter jacketed, heatable glass reaction vessel (with distillation head and condenser, and dropping funnel), 653.6 g of a 76.5% methanolic solid resin solution of an ethylene-vinyl acetate copolymer which has been obtained analogously to example B, contains 70.9 mol % of ethylene and 29.1 mol % of vinyl acetate, and has an average molecular weight Mw of 6872 g/mol were weighed in. Subsequently, the solution was heated with stirring (200 rpm, blade stirrer) to a jacket temperature of 60° C. Once the temperature had been attained, the hydrolysis process was started by dropwise addition of 820 g of a 6.1% by weight methanolic sodium hydroxide solution, corresponding to 50 g of solid NaOH=10.0% of the amount of solid resin. The metered addition was effected by twice adding alkali for 15 minutes each at an interval of 30 minutes.

After a hydrolysis time of 3.5 hours, the mixture was cooled from 60° C. to 23° C. with a ramp of −5° C./min. In the course of this, crystallization of the ethylene-vinyl alcohol copolymer occurred. Addition of 1000 g of water achieved the precipitation to give pulverulent particles with the desired particle size. Finally, the solid-liquid separation was undertaken by means of a suction filter.

The pulverulent solid could be removed very efficiently from the suspension. The filtercake on the suction filter was washed with 2 1 of water, and subsequently introduced back into the reaction vessel and resuspended with 1 1 of dist. water. At a jacket temperature of 50° C. and a stirrer speed of 100 rpm, residual solvent was removed under reduced pressure (stripping). Subsequently, the mixture was cooled back to room temperature (23° C.), the solid was again removed from the suspension by means of a suction filter, and the filtercake was washed with 2 1 of dist. water (very good flow-through). Finally, the product was dried in a vacuum drying cabinet.

A fine pulverulent, white EVOH having a hydrolysis number of 11.7 mg KOH/g was obtained.

Analyses:

Composition from ¹H NMR: 60.3% by weight (70.9 mol %) of ethylene; 1.8% by weight of vinyl acetate; 37.9% by weight of vinyl alcohol.

DSC analysis: Tg: 8.6° C., Tm (peak)=100.4° C., melt enthalpy Hm=65.2 J/g;

Particle size of the pulverulent product (Coulter analysis): surface area 4035 cm²/g; mean volume diameter Dv 231.7 μm; number-average particle size Dn (mean) 0.105 μm.

### Example 8

### Very Low Molecular Weight EVOH

Exactly as in example 7 except with altered workup: after the precipitation to give pulverulent particles with the desired particle size had been achieved by addition of 1000 g of water, the liquid-solid separation was carried out by means of a suction filter. The pulverulent solid could be removed very efficiently from the suspension. The filtercake on the suction filter was washed with 2 1 of water and subsequently dried in a vacuum drying cabinet. The removal of the residual solvent by again resuspending and vacuum distillation (stripping) was not undertaken. A fine pulverulent, white EVOH having a hydrolysis number of 26.7 mg KOH/g was obtained.

Analyses:

Composition from ¹H NMR: 59.6% by weight (70.9 mol %) of ethylene; 4.1% by weight of vinyl acetate; 36.3% by weight of vinyl alcohol.

DSC analysis: Tg: 1.3° C., Tm (peak)=97.8° C., melt enthalpy Hm=59.9 J/g;

Particle size of the pulverulent product (Coulter analysis): surface area 4104 cm²/g; mean volume diameter Dv 288.2 μm; number-average particle size Dn (mean) 0.106 μm.

### Example 9

### Very Low Molecular Weight EVOH

In a 3-liter jacketed, heatable glass reaction vessel (with distillation head and condenser, and dropping funnel), 1091.4 g of a 73.3% methanolic solid resin solution of an ethylene-vinyl acetate copolymer which has been obtained analogously to example B, contains 67.6 mol % of ethylene and 32.5 mol % of vinyl acetate, and has an average molecular weight Mw of 5520 g/mol were weighed in. Subsequently, the solution was heated with stirring (200 rpm, blade stirrer) to a jacket temperature of 80° C. Once the temperature had been attained, the hydrolysis process was started by adding dropwise 920 g of an 8.7% by weight methanolic sodium hydroxide solution, corresponding to 80 g of solid NaOH=10.0% of the amount of solid resin. The alkali was metered in within one hour. During the hydrolysis time of 2.5 hours, 821 g of methyl acetate/methanol solvent mixture were removed under reduced pressure and 342 g of methanol were added. After this time, the hydrolysis was terminated by addition of 25 ml of glacial acetic acid, i.e. neutralization was effected to pH=7.2.

Subsequently, the mixture was cooled with a temperature ramp of −1° C./min to 23° C., which crystallized the EVOH polymer. The precipitation was completed by addition of 800 g of water. Finally, the solid-liquid separation was undertaken by means of a suction filter. The pulverulent solid could be removed very efficiently from the suspension. The filtercake on the suction filter was washed with 2 1 of water, then introduced back into the reaction vessel and resuspended with 1 1 of dist. water. At a jacket temperature of 45° C. and a stirrer speed of 100 rpm, residual solvent was removed under reduced pressure (stripping). Subsequently, the mixture was cooled back to room temperature (23° C.), the solid was again removed from the suspension by means of a suction filter, and the filtercake was washed with 2 1 of dist. water (very good flow-through). Finally, the product was dried in a vacuum drying cabinet.

A fine pulverulent, white EVOH having a hydrolysis number of 8.4 mg KOH/g was obtained.

Analyses:

Composition from ¹H NMR: 56.65% by weight (67.6 mol %) of ethylene; 1.29% by weight of vinyl acetate; 42.06% by weight of vinyl alcohol.

DSC analysis: Tg: 7.9° C., Tm (peak)=99.8° C., melt enthalpy Hm=63.3 J/g;

Particle size of the pulverulent product (Coulter analysis): surface area 1235 cm²/g; mean volume diameter Dv 814.4 μm; number-average particle size Dn (mean) 0.105 μm.

### Example 10

### High Molecular Weight EVOH

In a 3-liter jacketed, heatable glass reaction vessel (with distillation head and condenser, and dropping funnel), 674.2 g of a 44.5% by weight methanolic solution of an ethylene-vinyl acetate copolymer which has been obtained analogously to example A, contains 43.72 mol % of ethylene and 56.28 mol % of vinyl acetate, and has a weight-average molecular weight Mw of 192 875 g/mol were weighed in. This solution was diluted by addition of 326 g of methanol so as to result in a 30% by weight solution. Subsequently, the solution was heated with stirring (200 rpm, blade stirrer) to a jacket temperature of 80° C. Once the temperature had been attained, the hydrolysis process was started by adding dropwise 330 g of a 9.1% by weight methanolic sodium hydroxide solution, corresponding to 30 g of solid NaOH=10% by weight of the amount of solid resin. The metered addition was effected by twice adding alkali for 15 minutes each at an interval of 30 minutes. During the metered addition and for 1 h 30 min thereafter, a total of 800 ml of methyl acetate/methanol solvent mixture was distilled off and 800 ml of methanol were added.

Subsequently, the hydrolyzed solution was cooled to 23° C. at a cooling rate of −0.3° C./min. The hydrolyzed solution was then stirred at 23° C. for 4 h, so that the ethylene-vinyl alcohol copolymer could crystallize. The mixture was then heated back to 40° C., and the precipitation to give the powder was achieved by addition of 1000 ml of water. After cooling to room temperature, a solid-liquid separation was undertaken by means of a suction filter. The precipitated, pulverulent solid could be removed very efficiently from the suspension.

The filtercake on the suction filter was washed with 2 1 of water, then introduced back into the reaction vessel and resuspended with 2 1 of dist. water. The residual solvent was then removed by distillation at a jacket temperature of 50° C. under reduced pressure (stripping). Subsequently, the mixture was cooled back to room temperature, the solid was again removed from the suspension by means of a suction filter, and the filtercake was washed with 2 1 of dist. water. The product was finally dried in a vacuum drying cabinet.

A fine pulverulent, white EVOH having a hydrolysis number of 0.0 mg KOH/g (100% fully hydrolyzed product) was obtained.

Analyses:

Composition from ¹H NMR: 33.08% by weight (43.72 mol %) of ethylene, 66.92% by weight of vinyl alcohol;

DSC analysis: Tg: 52.74° C., Tm (peak)=165.3° C., melt enthalpy Hm=87.9 J/g.

Particle size of the product (Coulter analysis): surface area 127.1 cm²/g; mean volume diameter Dv 769.5 μm; number-average particle size Dn (mean) 3.57 μm.

### Example 11

### High Molecular Weight EVOH, Addition of Water During Cooling

In a 3-liter jacketed, heatable glass reaction vessel (with distillation head and condenser, and dropping funnel), 1020 g of a 49.0% by weight methanolic solution of an ethylene-vinyl acetate copolymer which has been obtained analogously to example A, contains 29.82 mol % of ethylene and 70.18 mol % of vinyl acetate, and has a weight-average molecular weight Mw of 155 247 g/mol were weighed in. Subsequently, the solution was heated with stirring (200 rpm, blade stirrer) to a jacket temperature of 70° C. Once the temperature had been attained, the hydrolysis process was started by a dropwise addition of 556 g of a 9.0% by weight methanolic sodium hydroxide solution, corresponding to 50 g of solid NaOH=10% of the amount of solid resin. The metered addition was effected by twice adding alkali for 15 minutes each at an interval of 30 minutes. During the metered addition of the alkali, a total of 260 ml of methyl acetate/methanol solvent mixture were distilled off, and 300 ml of methanol were added.

Subsequently, the hydrolyzed solution was cooled at a cooling rate of −0.2° C./min to 40° C. With the stirrer stopped, neutralization was then effected by adding 200 ml of ethyl acetate, this was stirred in briefly at 50 rpm, and the mixture was left to stand without stirring for 10 min. 1500 ml of water were then added and stirred in briefly at 50 rpm. In the course of this, pulverulent precipitation occurred. The resulting suspension was then cooled with a ramp of 0.2° C./min to 23° C. in order to complete the crystallization of the ethylene-vinyl alcohol copolymer. A liquid-solid separation was then undertaken by means of a suction filter. The precipitated pulverulent solid could be removed very efficiently from the suspension.

The filtercake on the suction filter was washed with 2 1 of water, then introduced back into the reaction vessel and resuspended with 1 1 of dist. water. The residual solvent was then removed by distillation at a jacket temperature of 45° C. under reduced pressure (stripping). Subsequently, the mixture was cooled back to room temperature, the solid was again removed from the suspension by means of a suction filter, and the filtercake was washed with 3 1 of dist. water. The product was finally dried in a vacuum drying cabinet. A fine pulverulent, white EVOH having a hydrolysis number of 9.6 mg KOH/g was obtained.

Analyses:

Composition from ¹H NMR: 21.13% by weight (29.82 mol %) of ethylene; 1.48% by weight of vinyl acetate; 77.39% by weight of vinyl alcohol;

DSC analysis: Tg: 58.1° C., Tm (peak)=177.4° C., melt enthalpy Hm=67.7 J/g.

Particle size of the product (Coulter analysis): surface area 973.4 cm²/g; mean volume diameter Dv 574.4 μm; number-average particle size Dn (mean) 0.109 μm.

1-15. (canceled)

16. A process for preparing pulverulent ethylene-vinyl alcohol copolymers, comprising free-radically polymerizing ethylene and one or more vinyl esters, and optionally further monomers copolymerizable therewith to obtain an ethylene-vinyl ester copolymer, subsequently hydrolyzing the ethylene-vinyl ester copolymer to an ethylene-vinyl alcohol copolymer, and precipitating the ethylene-vinyl alcohol copolymer following hydrolysis in alcoholic solution, by means of cooling with a temperature gradient, and optional addition of water,
the temperature gradient for ethylene-vinyl alcohol copolymers derived from low molecular weight ethylene-vinyl ester copolymers having a weight-average molecular weight Mw of from 2000 to 100,000 g/mol being from −0.1° C./min to −10° C./min, and
the temperature gradient for ethylene-vinyl alcohol copolymers which are derived from high molecular weight ethylene-vinyl ester copolymers having a weight-average molecular weight Mw of >100,000 g/mol being from −0.1° C./min to −1° C./min, and isolating a pulverulent ethylene-vinyl alcohol polymer.

17. The process of claim 16, wherein cooling is maintained until a temperature which is above the Tg of the ethylene-vinyl alcohol copolymer but below the melting point of the ethylene-vinyl alcohol copolymer is reached.

18. The process of claim 16, wherein the high molecular weight ethylene-vinyl alcohol copolymer is first cooled to a temperature of from 40° C. to 70° C. with a temperature gradient of from −1° C./min to −10° C./min, and the cooling is subsequently continued down to a temperature of from 10° C. to 35° C. at a lower temperature gradient of from −0.1° C./min to −1° C./min.

19. The process of claim 17, wherein the high molecular weight ethylene-vinyl alcohol copolymer is first cooled to a temperature of from 40° C. to 70° C. with a temperature gradient of from −1° C./min to −10° C./min, and the cooling is subsequently continued down to a temperature of from 10° C. to 35° C. at a lower temperature gradient of from −0.1° C./min to −1° C./min.

20. The process of claim 16, wherein the precipitation of the ethylene-vinyl alcohol copolymer is promoted by addition of water.

21. The process of claim 17, wherein the precipitation of the ethylene-vinyl alcohol copolymer is promoted by addition of water.

22. The process of claim 18, wherein the precipitation of the ethylene-vinyl alcohol copolymer is promoted by addition of water.

23. The process of claim 20, wherein the amount of water added is from 0.3 to 5.0 times the weight of the ethylene-vinyl acetate copolymer.

24. The process of claim 21, wherein the amount of water added is from 0.3 to 5.0 times the weight of the ethylene-vinyl acetate copolymer.

25. The process of claim 22, wherein the amount of water added is from 0.3 to 5.0 times the weight of the ethylene-vinyl acetate copolymer.

26. The process of claim 16, wherein the pulverulent ethylene-vinyl alcohol polymer is resuspended in water, solvent residues are optionally removed by distillation or stripping, and the pulverulent product is isolated by filtration.

27. A foil, film or laminate, comprising at least one ethylene-vinyl alcohol copolymer prepared by the process of claim 16.

28. A molding prepared from an ethylene-vinyl alcohol copolymer prepared by the process of claim 16.

29. A coating composition comprising at least one ethylene-vinyl alcohol copolymer prepared by the process of claim 16.

30. An additive for a powder coating composition comprising at least one ethylene-vinyl alcohol copolymer prepared by the process of claim 16.

31. An adhesive, comprising at least one ethylene-vinyl alcohol copolymer prepared by the process of claim 16.

32. A polymer binder in a building material containing an inorganic hydraulically setting binder, wherein at least one polymer binder comprises an ethylene-vinyl alcohol copolymer prepared by the process of claim 16.
